(19) United States
(12) Patent Application Publication
(10) Pub. No.: US 2004/0197068 A1
(43) Pub. Date: Oct. 7, 2004

(54) IF-energizable visible-light emitting synthetic fiber

(76) Inventor: Gianfranco Feldi, Sandigliano (IT)

Correspondence Address: James V. Costigan, Esq., Hedman & Costigan, P.C., Suite 2003, 1185 Avenue of the Americas, New York, NY, 10036-2646, US

(21) Appl. No.: 10/464,976

(22) Filed: Jun. 19, 2003

(30) Foreign Application Priority Data
Apr. 4, 2003 (IT) MI2003A-000674

(51) Int. Cl. G02B 6/00

(52) U.S. Cl. 385/143; 385/142

(57) ABSTRACT

The present invention relates to a synthetic fiber adapted to emit a visible light as it is energized by an infrared light, which fiber has the main feature that it is made of a polymeric compound, to which a masterbatch holding a rare earth oxysulphide active substance is added.

### BACKGROUND OF THE INVENTION

The present invention relates to a synthetic fiber, adapted to emit a visible light, as it is energized by an infrared (IF) light.

As is known, in the textile field are conventionally used several types of fibers with different touch and chromatic features, as well as different plastic materials forming said fibers.

### SUMMARY OF THE INVENTION

The aim of the present invention is to provide a novel synthetic fiber, adapted to emit a visible light, as it is energized by an infrared light, allowing to greatly broaden its application ranges and its functional properties.

Within the scope of the above mentioned aim, a main object of the present invention is to provide such a synthetic fiber which is also adapted to be used as an antiforgery element in cloth articles, and which, moreover, provides very good aesthetic effects in the presence of an infrared light.

Another object of the present invention is to provide such a synthetic fiber which is designed for providing very good aesthetic effects, to be advantageously used in the cloth, furnishing, motor vehicle fields and the like.

Yet another object of the present invention is to provide such a synthetic fiber which, owing to its specifically designed features is very reliable and safe in operation.

Yet another object of the present invention is to provide such a synthetic fiber which can be easily made starting from easily commercially available elements and materials and which, moreover, is very competitive from a mere economic standpoint.

According to one aspect of the present invention, the above mentioned aim and objects as well as yet other objects, which will become more apparent hereinafter, are achieved by a synthetic fiber adapted to emit a visible light, as said fiber is energized by an infrared light, characterized in that said fiber is made of a polymeric compound to which a masterbatch holding a rare earth oxysulphide active substance is added.

Further characteristics and advantages of the present invention will become more apparent hereinafter from the following detailed disclosure of a preferred, though not exclusive, embodiment of a synthetic fiber designed for emitting a visible light, as it is energized by an infrared (IF) light, which is illustrated, by way of an indicative, but not limitative, example, in the following disclosure.

More specifically, the synthetic fiber according to the present invention has the feature that it appears as white or of any other color, as said fiber is in the presence of visible light, but is so made and/or designed, as to modify its intrinsic or inherent color, in a color broad range, as said fiber is impinged upon by an infrared light, i.e. a light having a wavelength greater than 780 nm.

According to one aspect of the present invention, the fiber is made starting from a polymeric compound, such as a polyester resin, in particular polyethylene terephthalate or polypropylene.

In particular, the fiber is made by a continuous spinning process, in which is extruded a polymer including 10% of a masterbatch which can hold up to 1% of an active substance based on a rare earth oxysulphide.

Said masterbatch is made by mixing or blending, in a mixing device having a mixing arm provided with a double rotary movement, i.e. a perimetrical rotary movement and an axial rotary movement, for 20 minutes, to provide a powder which, advantageously, comprises up to 10% of a powder additive based on a rare earth oxysulphide.

The powder additive, preferably, comprises particles having, in a rate of 50%, a particle size of about 1.5 μm.

Moreover, in a rate of 45%, said particles have a maximum size of 10 μm, and it is also possible to provide 5% of particles less than 0.3 μm.

The additive material is energized as it is subjected to infrared rays or beams having a wavelength greater than 780 nm, with characteristic peaks at about 980 μm, thereby providing, inside the visible spectrum, an emitted visible light with peaks at different colors.

The masterbatch advantageously further comprises 30% of an optical whitening material, such as TᵢO₂ powder, providing the polymeric fiber with a white color (if the desired starting color of the fiber is white) as the fiber is not energized by infrared light.

Moreover, said masterbatch can also comprise 60% of powder polybutylene terephthalate, used as a support material therefor, if polyethylene terephthalate is advantageously used, or powder propylene, if polypropylene is advantageously used.

The mixture is extruded at a temperature of about 270° C. for the polybutylene terephthalate based support material, or of about 220° C. for the polypropylene based supporting materials.

The mixture is transformed into cylindrical shape grains having a length of 2 mm and a diameter less than 1 millimeter.

The fiber is made by spinning the polyester or polypropylene polymer, and adding the above masterbatch in an amount corresponding to about 10% after having dried said masterbatch in hot air at 160° C. and with a condensating temperature or dew point of −50° C., in the case of PBT.

It is possible to make end fibers having very different fiber counts, from 50 to 440 dTex.

The fiber, in particular, is made with such a burr number, so as to provide a count/burr ratio of about 2-6.

The fiber is spun in the form of a partially oriented yarn, and it can be subjected to further processing operations, such as texturizing, air texturing, stretching, twisting and warding processes.

The thus made fiber, which will be made as a yarn for making fabrics in general, allows to provide very good optical effects, which greatly broaden the fiber use range.

In fact, said fiber can be arranged with any desired pattern, and it can also be used as a antiforgery material, or for making fabrics of specifically designed aesthetic effects, as they are used for making cloth articles in general.

While the fiber of the invention has been disclosed with reference to a preferred embodiment thereof, it should be apparent that the disclosed embodiment is susceptible to several modifications and variations all of which will come within the scope of the invention.

1. A synthetic adapted to emit a visible light, as said fiber is energized by an infrared light, characterized in that said fiber is made of a polymeric compound to which a masterbatch holding a rare earth oxysulphide active substance is added.

2. A synthetic fiber, according to the preceding claim, characterized in that said polymeric compound comprises polyester.

3. A synthetic fiber, according to claim 2 or 2, characterized in that said polyester comprises polyethylene tereftalate.

4. A synthetic fiber, according to claim 1, characterized in that said polymeric compound comprises polypropylene.

5. A synthetic fiber, according to claim 1, characterized in that said masterbatch is included in a rate of substantially up to 10%.

6. A synthetic fiber, according to claim 1, characterized in that said rare earth oxysulphide base active substance is included in a rate substantially up to 1%.

7. A synthetic fiber, according to claim 1, characterized in that said masterbatch comprises, substantially, up to 10% of a powder additive based on a rare earth oxysulphide, 30% of an optical whitening agent, in powder form, with TᵢO₂ or other coloring agents, and 60% of a polymeric compound.

8. A synthetic fiber, according to claim 1, characterized in that said synthetic fiber is made starting from a mixture containing polybutilene tereftalate and extruding said mixture at a temperature of substantially 270° C.

9. A synthetic fiber, according to claim 8, characterized in that said polypropylene containing mixture is extruded at a temperature of substantially 220° C.

10. A synthetic fiber, according to claim 1, characterized in that said masterbatch, if based on PBT, is dried in hot air at a temperature of 160° C. and with a condensating temperature of −50° C.

11. A synthetic fiber, according to claim 1, characterized in that said synthetic fiber is spun to provide a yarn having an end count from 50 to 440 dTex.

12. A synthetic fiber, according to claim 11, characterized in that said spun yarn has a count/burr number ratio of substantially 2-6.

13. A synthetic fiber, according to claim 1, characterized in that said synthetic fiber is used for providing antiforgery elements.

14. A synthetic fiber, according to claim 1, characterized in that said synthetic fiber is used for providing aesthetic effects under an infrared light, for the cloth, furnishing, motor vehicle fields and in technical applications.
